(19) United States
(12) Patent Application Publication
(10) Pub. No.: US 2026/0119898 A1
(43) Pub. Date: Apr. 30, 2026

(54) APPARATUS AND METHOD FOR LEARNING TEMPORAL DISTANCE COGNITIVE REPRESENTATION

(71) Applicant: UIF (UNIVERSITY INDUSTRY FOUNDATION), YONSEI UNIVERSITY, Seoul (KR)

(72) Inventors: Youngwoon Lee, Seoul (KR); Junik Bae, Seoul (KR)

(73) Assignee: UIF (UNIVERSITY INDUSTRY FOUNDATION), YONSEI UNIVERSITY, Seoul (KR)

(21) Appl. No.: 18/933,805

(22) Filed: Oct. 31, 2024

(30) Foreign Application Priority Data
Oct. 28, 2024 (KR) 10-2024-0149026

(51) Int. Cl. G06N 3/092

(52) U.S. Cl. CPC G06N 3/092

(57) ABSTRACT

Disclosed are an apparatus and method for learning temporal distance-aware representations and method, and the apparatus includes: an initialization unit configured to initialize a buffer where a goal-conditioned policy, an exploration policy, visual distance-aware representation, and experience data for learning are stored; a learning execution unit configured to set a goal based on a Temporal Distance-aware Representations (TLDR) reward in a current episode, and determine a new state and action data through execution of the goal-conditioned policy and the exploration policy to reach the goal; a policy learning unit configured to learn the goal-conditioned policy based on experience of reaching the goal, and learn the exploration policy based on a visual distance to the goal; and a visual distance-aware representations learning unit configured to learn the visual distance-aware representations by encoding a visual distance between the states based on constraints.

### CROSS-REFERENCE TO RELATED APPLICATION

This application claims under 35 U.S.C. § 119 (a) the benefit of Korean Patent Application No. 10-2024-0149026 filed on Oct. 28, 2024, the entire contents of which is incorporated herein by reference.

### TECHNICAL FIELD

The present disclosure relates to a robot learning technology, and more particularly, to an apparatus and method for learning temporal distance-aware representations to provide an unsupervised GCRL method utilizing temporal distance-aware representations (TLDR), thereby enhancing both goal-directed exploration and goal-conditioned policy learning.

### BACKGROUND

Babies may autonomously learn goal-reaching skills, starting with controlling their bodies and gradually improving their ability to achieve more challenging goals. Similarly, for intelligent agents such as robots, the ability to reach a broad set of states, including environmental states and agent states, is critical. This ability not only serves as a foundational skill set by itself, but also contributes to accomplishing more complex tasks.

This raises the question of whether robots may autonomously learn these long-term goal-reaching skills like humans. If robots may autonomously learn long-term goal-reaching skills like humans, it could offer significant advantages. This is because learning goal-reaching action is independent of specific tasks and does not require external supervision, providing a scalable approach for autonomous robot learning. However, existing unsupervised goal-conditioned reinforcement learning (GCRL) and skill discovery methods have limited coverage of reachable states in complex environments.

A major challenge in unsupervised GCRL is exploring diverse states so the agent may achieve a variety of goals. Previous methods have focused on exploring a new state or those with high uncertainty in next-state predictions, but these methods may not uncover meaningful states or state transitions. Moreover, maximizing sparse goal achievement rewards or heuristically minimizing the distance to a goal is insufficient for long-term goal-reaching action in complex environments.

### PRIOR ART LITERATURE

### Patent Document

Korean Patent Application Publication No. 2024-0063147 (May 9, 2024)

### DESCRIPTION

### Problem to be Solved

The present disclosure also provides an apparatus and method for learning temporal distance-aware representations (TLDR), by which a goal is set based on TLDR rewards and a new state and action data are determined through execution of a goal-conditioned policy and an execution of the exploration policy.

The present disclosure also provides an apparatus and method for learning temporal distance-aware representations (TLDR), by which a goal-conditioned policy is updated by learning action data using Hindsight Experience Replay (HER) technique to maximize a probability of reaching a goal through the goal-conditioned policy.

The present disclosure also provides an apparatus and method for learning temporal distance-aware representations (TLDR), by which optimization of constraints is performed to prevent distortion of a visual distance between states and visual distance-aware representations are implemented using a neural network that encodes a visual distance between states in a latent space.

### Solution

In one general aspect, there is provided an apparatus for learning temporal distance-aware representations, and the apparatus includes: an initialization unit configured to initialize a buffer where a goal-conditioned policy, an exploration policy, visual distance-aware representations, and experience data for learning are stored; a learning execution unit configured to set a goal based on a Temporal Distance-aware Representations (TLDR) reward in a current episode, and determine new state and action data through the execution of the goal-conditioned policy and the exploration policy to reach the goal; a policy learning unit configured to learn the goal-conditioned policy based on experience of reaching the goal, and learn the exploration policy based on the visual distance to the goal; and a visual distance-aware representations learning unit configured to learn the visual distance-aware representations by encoding the visual distance between the states based on constraints.

The initialization unit may initialize the goal-conditioned policy through goal setting and initialize the exploration policy through the generation of actions for exploration.

The learning execution unit may sample the state of the current episode, sample a mini-batch from the buffer, and then select the state with the highest TLDR reward from the mini-batch to set the goal.

The learning execution unit may execute the goal-conditioned policy for a predetermined period of time to determine whether the goal has been reached or whether a predetermined stage before the goal has been reached.

The learning execution unit may, when it is determined that the goal or the predetermined stage has been reached, execute the exploration policy and store the determined new state and action data in the buffer.

The policy learning unit may update the goal-conditioned policy by learning the action data to maximize the probability of reaching the goal through the goal-conditioned policy using the Hindsight Experience Replay (HER) technique.

The policy learning unit may select the action data by performing reinforcement learning to minimize the visual distance through a loss function.

The policy learning unit may learn the exploration policy by expanding the state space for the exploration of various states and discovering a new state that the agent can move to based on the visual distance to the goal.

The visual distance-aware representations learning unit may perform optimization of the constraints to prevent distortion of the visual distance between the states and implement the visual distance-aware representations using a neural network that encodes the visual distance between the states in latent space.

The visual distance-aware representations learning unit may optimize the visual distance-aware representations by performing optimization of the constraints and maximizing the visual distance using a double gradient descent method.

In another aspect, there is provided a method for learning temporal distance-aware representations performed by an apparatus for learning temporal distance-aware representations, and the method includes: initializing a buffer where a goal-conditioned policy, an exploration policy, visual distance-aware representations, and experience data for learning are stored; setting a goal based on a Temporal Distance-aware Representations (TLDR) reward in the current episode, and determining new state and action data through the execution of the goal-conditioned policy and the exploration policy to reach the goal; learning the goal-conditioned policy based on experience of reaching the goal, and learning the exploration policy based on the visual distance to the goal; and learning the visual distance-aware representations by encoding the visual distance between the states based on constraints.

### EFFECT

The disclosed technology may have the following effects. However, the scope of the disclosed technology should not be construed as being limited by the above, as it does not imply that a specific embodiment must necessarily include all, or only, the following effects.

In the apparatus and method for learning temporal distance-aware representations according to one embodiment of the present disclosure, it is possible to set a goal based on TLDR rewards and determine a new state and action data through execution of a goal-conditioned policy and an execution of the exploration policy.

In the apparatus and method for learning temporal distance-aware representations according to one embodiment of the present disclosure, it is possible to update a goal-conditioned policy by learning action data using Hindsight Experience Replay (HER) technique to maximize a probability of reaching a goal through the goal-conditioned policy.

In the apparatus and method for learning temporal distance-aware representations according to one embodiment of the present disclosure, it is possible to perform optimization of constraints to prevent distortion of the visual distance between states, and to implement visual distance-aware representations using a neural network that encodes a visual distance between states in a latent space.

### BRIEF DESCRIPTION OF THE DRAWINGS

FIG. 1 is a drawing showing a TLDR algorithm according to one embodiment of the present disclosure.

FIG. 2 is a drawing showing the functional configuration of an apparatus for learning temporal distance-aware representations according to one embodiment of the present disclosure.

FIG. 3 is a flowchart illustrating a method for learning temporal distance-aware representations according to one embodiment of the present disclosure.

FIG. 4 is a drawing showing an embodiment of a state-based environment and a pixel-based environment according to one embodiment of the present disclosure.

FIG. 5 is a drawing showing the state coverage of state-based environments according to the experimental results of FIG. 4.

FIG. 6 is a diagram explaining goal achievement indicators of a goal-conditioned policy according to the experimental results of FIG. 4.

FIG. 7 is a drawing showing the experimental results in a pixel-based environment according to the experimental results of FIG. 4.

FIG. 8 is a drawing showing the goal-reaching capability in AntMaze-Ultra.

FIG. 9 is a drawing showing the influence of temporal distance-aware representations in exploration and GCRL reward design.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

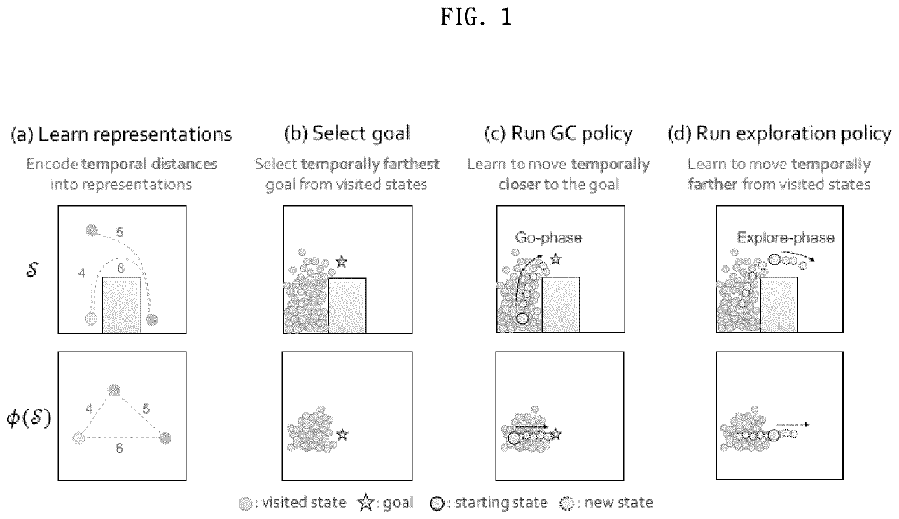

FIG. 1 is a drawing showing a TLDR algorithm according to one embodiment of the present disclosure.

Referring to FIG. 1, a TemporaL Distance-aware Representations (TLDR) algorithm may utilize temporal distance-aware representations for unsupervised goal-conditioned reinforcement learning (GCRL).

First, the TLDR algorithm learns the state encoder φ to map states into temporal distance-aware representations (a). Here, the temporal distance-aware representations may correspond to the minimum number of environmental steps (transition steps) between two states, and may correspond to, for example, a process of defining a distance between two states as a temporal distance in the environment. Additionally, a state may correspond to environmental information at a current point in time during which an agent interacts with the environment, and may, for example, include all important information about the environment at a particular point in time (e.g., position, speed, surrounding elements, etc.).

The TLDR algorithm may select a temporally farthest state from visited states as an exploration goal through the temporal distance-aware representations (b). Here, by determining the farthest state among the visited states as the exploration goal, the TLDR algorithm may explore a wider space during an exploration process and efficiently expand a state space of the environment. That is, the TLDR algorithm may explore a wider space and acquire new information by exploring a goal state that are far away, rather than a relatively close state.

The TLDR algorithm may reach a goal selected using a goal-conditioned policy and may learn to minimize a temporal distance to the goal (c). Here, the goal-conditioned policy may refer to a policy that enables an agent to learn how to reach a set goal. The TLDR algorithm may explore for an optimized action sequence to reach a selected goal state. For example, the TLDR algorithm may minimize the temporal distance by calculating a temporal distance between the current state and the goal state and selecting actions to minimize a time required to reach the goal.

Afterwards, the TLDR algorithm may collect exploration paths by visiting states with large temporal distances from the visited states through the exploration policy (d). Here, the exploration policy may refer to a course of actions to explore a new state in the environment and gather more information. Here, the TLDR algorithm may cover more state spaces and improve understanding of the environment by visiting states with large temporal distances and collecting exploration paths according to the states.

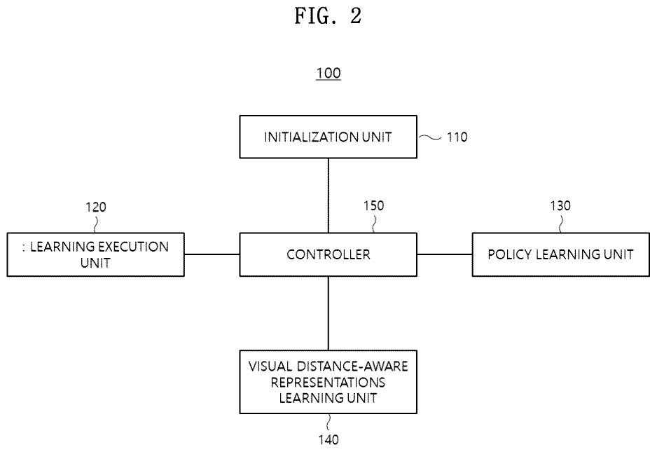

FIG. 2 is a drawing showing an apparatus for learning temporal distance-aware representations according to one embodiment of the present disclosure.

Referring to FIG. 2, an apparatus 100 for learning temporal distance-aware representations may include an initialization unit 110, a learning execution unit 120, a policy learning unit 130, a visual distance-aware representations learning unit 140, and a controller 150.

At this time, the embodiments of the present disclosure do not necessarily include all of the above components simultaneously, and may be implemented by omitting some components or selectively including some or all of them, depending on each embodiment. Hereinafter, the operation of each component will be described in detail.

The initialization unit 110 may initialize a buffer where a goal-conditioned policy, an exploration policy, visual distance-aware representations, and experience data for learning are stored. Here, the goal-conditioned policy may refer to a policy by which an agent learns how to reach a set goal, and the exploration policy may refer to how the agent discovers a new state while exploring the environment and accumulates various experiences in the process. Additionally, the experience data may refer to data obtained from the environment while the agent is learning. The initialization unit 110 may initialize the buffer before learning and may store a goal-conditioned policy, an exploration policy, visual distance-aware representations, and experience data, which are set by the agent, in the buffer. The initialization unit 110 may maximize the efficiency of learning by initializing the buffer where the agent will store data collected through interaction with the environment.

In one embodiment, the initialization unit 110 may initialize the goal-conditioned policy through goal setting and initialize an exploration policy through generation of actions for exploration. Here, the initialization unit 110 may initialize a goal-conditioned policy by setting a goal that includes a specific condition for a location, state, and environment that the agent should reach. For example, when performing goal setting, the initialization unit 110 may initialize an existing goal-conditioned policy of the buffer and perform an exploration action to reach the set goal. Here, the exploration action may refer to gathering environmental experience to discover a new state or path while exploring the environment to reach the goal. Here, the goal-conditioned policy may be defined by the following Equation 1.

$${r}^{G} ( s , {s}^{′} , g ) = ‖ ϕ ( s ) - ϕ ( g ) ‖ - ‖ ϕ ( {s}^{′} ) - ϕ ( g ) ‖ . \qquad [ Equation 1 ]$$

Additionally, the initialization unit 110 may initialize the exploration policy by generating an exploration action that aims to discover a new state or path while exploring the environment. When an exploration action is generated, the initialization unit 110 may initialize an existing exploration policy and perform a new exploration policy to discover an optimal path to reach a specific condition for a location, state, and environment that the agent should reach according to goal setting. Here, the exploration policy may be defined by the following Equation 2.

$${r}^{E} ( s , {s}^{′} ) = {r}_{TLDR} ( {s}^{′} ) - {r}_{TLDR} ( s ) . \qquad [ Equation 2 ]$$

The learning execution unit 120 may set a goal based on a Temporal Distance-aware Representations (TLDR) reward in a current episode, and may determine a new state and action data through execution of a goal-conditioned policy and execution of the exploration policy to reach the goal. Here, an episode may refer to a sequence of experiences in reinforcement learning where the agent starts interacting with the environment and continues until a goal is achieved or the predefined time ends. For example, one episode may be composed of the agent's states, actions, and rewards from a starting point to a goal point. Additionally, a TLDR reward may refer to a reward given to the agent during a learning process considering a temporal distance between states. For example, a TLDR reward may be calculated based on the time required for the agent to reach a goal state. The learning execution unit 120 may determine an action to reach a goal based on a goal-conditioned policy. TLDR rewards may be expressed by the following Equation 3.

$${r}_{TLDR} ( s ) = log ( 1 + \frac{1}{k} {\sum }_{{z}^{( j )} ∈ {N}_{k} ( ϕ ( s ) )} ‖ ϕ ( s ) - {z}^{( j )} ‖ ) \qquad [ Equation 3 ]$$

Here, Nₖ(·) may denote a k-nearest neighboring goal around φ(s) within a single mini-batch. A mini-batch may be a method for dividing an entire dataset into predetermined units and utilizing the divided data for learning.

For example, the learning execution unit 120 may control the agent to perform specific actions, such as going straight, turning left, and turning right, to reach a particular goal. However, aspects of the present disclosure are not limited thereto, and the learning execution unit 120 may also control the agent to avoid obstacles. In addition, the learning execution unit 120 may discover a new state and path to reach a goal based on an exploration policy. For example, the learning execution unit 120 may discover a new path to reach a goal more quickly through an exploration policy. However, aspects of the present disclosure are not limited thereto, and the learning execution unit 120 may explore for a new path according to a current state of the agent.

In one embodiment, the learning execution unit 120 may determine a new state and action data through execution of a goal-conditioned policy and execution of an exploration policy. For example, the learning execution unit 120 may reach a new state, as a result of actions performed by the agent through the goal-conditioned policy and the exploration policy. Here, the learning execution unit 120 may store, in the buffer, action data (e.g., going straight, turning left and right, changing speed, etc.) taken by the agent in the process of reaching a new state. However, aspects of the present disclosure are not limited thereto, and the learning execution unit 120 may also store in the buffer information about the new state, including coordinates, speed, direction, etc. In one embodiment, the learning execution unit 120 may update the goal-conditioned policy and the exploration policy through learning about the a new state and action data and store the updated policies in the buffer.

In one embodiment, the learning performer 120 may set a goal by sampling a state of a current episode, sampling a mini-batch from the buffer, and then selecting a state with a highest TLDR reward from the mini-batch. The learning execution unit 120 may sample the current episode's states and mini-batches, randomly select some of the states and experience data stored in the buffer, and use the selected states for learning of the agent. Here, the learning execution unit 120 may set a goal by sampling the states and mini-batches of the current episode and selecting a state with a largest temporal distance as a next goal.

In one embodiment, the learning execution unit 120 may execute a goal-conditioned policy for a predetermined period of time to determine whether the goal has been reached or whether a predetermined stage before the goal has been reached. Here, the learning execution unit 120 may set a goal and evaluate a degree of achievement of the goal based on a result of executing the goal-conditioned policy for a predetermined period of time. For example, the learning execution unit 120 may execute the goal-conditioned policy for an estimated time for the agent to reach the goal based on a temporal distance, and evaluate a degree of achievement of the goal. Here, when the agent reaches the goal within the estimated time, the learning execution unit 120 may record in the buffer that the agent has achieved the goal. In addition, when the agent reaches a predetermined stage before the goal, the learning execution unit 120 may incorporate a corresponding state into a learning process and update the goal-conditioned policy to reach the next state.

In one embodiment, when it is determined that the goal or the predetermined stage has been reached, the learning execution unit 120 may store, in the buffer, the a new state and action data which are determined through the execution of the exploration policy. Here, by executing the exploration policy when the agent reaches a goal state, the learning execution unit 120 may allow the agent to select an action so that the agent can explore for a new state. When the agent reaches a specific goal, the learning execution unit 120 may perform a process of exploring a new state through the exploration policy, instead of staying at the specific goal. For example, the learning execution unit 120 may select an action to move to a new state where a largest reward according to a visual distance is set.

The policy learning unit 130 may learn a goal-conditioned policy based on the experience of reaching a goal, and may learn an exploration policy based on a visual distance to the goal. Here, the policy learning unit 130 may learn the goal-conditioned policy based on actions performed by the agent in the environment to reach a specific goal state in reinforcement learning, along with the resulting outcomes (e.g., state transition and reward, etc.). Additionally, the policy learning unit 130 may learn the exploration policy for learning action to explore a new state based on a visual distance between the goal and the current state. Here, the policy learning unit 130 may collect state transition data experienced by the agent in the environment and learn an exploration policy in the direction of maximizing the visual distance between the goal and the current state.

In one embodiment, the policy learning unit 130 may update the goal-conditioned policy by learning action data to maximize a probability of reaching the goal through the goal-conditioned policy using Hindsight Experience Replay (HER) technique. Here, the HER technique may refer to a technique for learning a goal-conditioned policy based on experience of failing to reach a goal. For example, the policy learning unit 130 may learn about a state, action, reward, and next state of an experience in which the agent failed to reach the goal, and update the goal-conditioned policy. Here, the policy learning unit 130 may set a state in which the goal has not been reached as a new goal, and learn the goal-conditioned policy based on the experience of reaching the set state. The policy learning unit 130 may learn a temporal distance between a state and a new goal state and update the goal-conditioned policy according to the probability of transition between states.

In one embodiment, by performing reinforcement learning to minimize the visual distance through a loss function, the policy learning unit 130 may select action data. Here, the loss function may refer to a function that represents performance indicators required for the agent to reach the goal or become close to the goal. By perform reinforcement learning to minimize the loss function, the policy learning unit 130 may allow the agent to select an action to become closer to the goal. For example, by performing reinforcement learning in a direction that minimizes a temporal distance between a state and a goal state, the policy learning unit 130 may select action data in a direction to increase a probability for the agent to reach the goal state.

In one embodiment, the policy learning unit 130 may learn the exploration policy by expanding a state space for exploration of various states and discovering a new state to which the agent can move based on a visual distance to the goal. Here, the state space may correspond to a set of states that the agent can explore and move to. The policy learning unit 130 may discover a new state based on the visual distance to the goal so that the agent may move to a wider range of states. For example, the policy learning unit 130 may set the exploration policy to receive a higher reward when discovering a new state, so that a new state are discovered through actions in which the agent moves to a state with a greater visual distance.

The visual distance-aware representations learning unit 140 may learn visual distance-aware representations by encoding a visual distance between states based on constraints. Here, a constraint may correspond to a condition for controlling a distance between states so that the distance is not distorted during a visual distance-aware representations learning process.

In addition, by setting constraints and performing encoding of a visual distance between states based on the constraints, the visual distance-aware representations learning unit 140 may numerically express the visual distance in a latent space. By performing learning on the encoded visual distance, the visual distance-aware representations learning unit 140 may determine the agent's goal-conditioned policy and exploration condition according to a distance between states.

In one embodiment, the visual distance-aware representations learning unit 140 may perform constraint optimization to prevent distortion of the visual distance between states, and implement visual distance-aware representations using a neural network that encodes the visual distance between states in a latent space. Here, the visual distance-aware representations learning unit 140 may perform optimization of constraints based on a Lagrange multiplier and a constrained optimization technique. In addition, the visual distance-aware representations learning unit 140 may encode a visual distance between states based on the constraints in a latent space through a neural network. For example, the visual distance-aware representations learning unit 140 may learn a distance between states through a neural network, perform encoding according to a probability of transition to a goal state, and implement a visual distance-aware representation.

Here, the visual distance-aware representations according to the constraints may be defined by the following Equation 4.

$${max}_{ϕ} {𝔼}_{\text{?} ∼ \text{?} , g ∼ \text{?}} [ ‖ f ( ϕ ( s ) - ϕ ( g ) ) ‖ ] s . t . {𝔼}_{( s , a , {s}^{′} ) ∼ {p}_{\text{?}}} [ ‖ ϕ ( s ) - ϕ ( {s}^{′} ) ‖ ] \leq 1 \qquad [ Equation 4 ]$$

$$\text{?} \text{indicates text missing or illegible when filed}$$

Here, f may correspond to an affine transformed softplus function that assigns a lower weight to a larger distance ∥φ(s)−φ(g)∥. The visual distance-aware representations learning unit 140 may optimize a constraint objective using dual gradient descent with Lagrange multiplier λ, and randomly sample s and g from mini-batches during learning.

In one embodiment, the visual distance-aware representations learning unit 140 may performs optimization of the visual distance-aware representations and maximization of the constraints using a dual gradient descent method. Here, the dual gradient descent technique may be a technique for optimizing both an objective function and constraints simultaneously in a constrained optimization problem. For example, the dual gradient descent technique may involve cross-optimizing variables of the objective function and optimizing a Lagrange multiplier. By maximizing the visual distance that satisfies constraints based on the dual gradient descent method, the visual distance-aware representations learning unit 140 may optimize the visual distance-aware representations so that the agent can reach a goal state or explore a new state.

The controller 150 may control the overall operation of the apparatus 100 and may manage the control flow or data flow between the initialization unit 110, the learning execution unit 120, the policy learning unit 130, and the visual distance-aware representations learning unit 140.

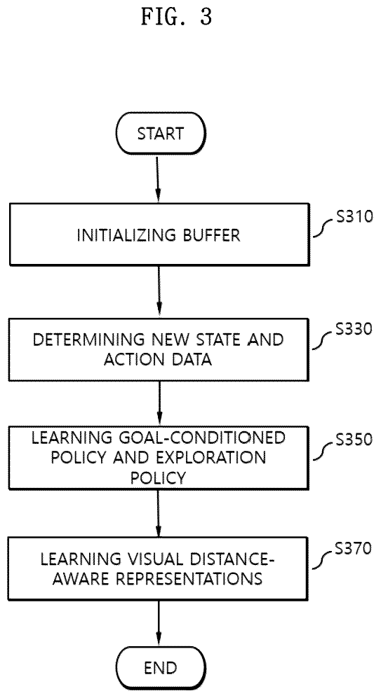

FIG. 3 is a flowchart explaining a method for learning temporal distance-aware representations according to the present disclosure.

Referring to FIG. 3, an apparatus 100 for learning temporal distance-aware representations may initialize, through an initialization unit 110, a buffer for storing a goal-conditioned policy, an exploration policy, visual distance-aware representations, and experience data for learning (step S310). an apparatus 100 may set a goal based on a Temporal Distance-aware Representations (TLDR) reward in a current episode using a learning execution unit 120, and may determine a new state and action data through execution of a goal-conditioned policy and an exploration policy to reach the goal (step S330).
an apparatus 100 may learn the goal-conditioned policy based on experience of reaching the goal using the policy learning unit 130, and learn the exploration policy based on a visual distance to the goal (step S350). an apparatus 100 may learn visual distance-aware representations by encoding the visual distance between states based on constraints using a visual distance-aware representations learning unit 140 (step S370).

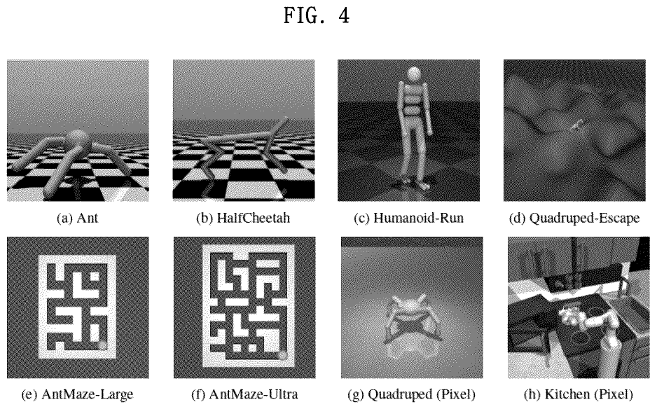

FIG. 4 is a drawing showing an embodiment of a state-based environment and a pixel-based environment according to one embodiment of the present disclosure.

In FIG. 4, an experiment is conducted on TLDR where temporal distance-aware representations are used in eight robot walking and manipulation environments.

State-based environments include Ant and HalfCheetah from OpenAI Gym, Humanoid-Run and Quadruped-Escape from DeepMind Control Suite (DMC), AntMaze-Large from D4RL, and AntMaze-Ultra. For Humanoid-Run and Quadruped-Escape, 3D coordinates of an agent are included in an observation value. For pixel-based environments, Quadruped (Pixel) from METRA[1] and Kitchen (Pixel) from D4RL [33] are used, with the image size of 64×64×3 as an observation value.

Next, the method of the present disclosure is compared with six prior unsupervised GCRL, skill discovery, and exploration methods. For state-based environments, the comparison is conducted with METRA, PEG, APT, RND, and Disagreement. For pixel-based environments, the comparison is conducted with METRA and LEXA. Here, the meaning of each term is as follows.
METRA: the state-of-the-art unsupervised skill discovery method which uses temporal distance-aware representations
PEG: the state-of-the-art unsupervised GCRL method which plans to obtain a goal with a maximum exploration rewards
LEXA: the method that uses a world model to train an Achiever and Explorer policy
APT: the method that maximizes an entropy reward estimated from a k-nearest neighbor in a minibatch
RND: the method that uses the distillation loss of a network to a random target network as a reward

Disagreement: the method that utilizes the disagreement among an ensemble of world models as a reward.

Following METRA [1] and PEG [2], unsupervised exploration is evaluated using state coverage or queue state coverage, and goal-reaching performance is evaluated using a goal distance or the number of reached goals (achieved tasks). Here, state coverage is measured by calculating the number of 1×1 sized (x, y)-bins (x-bins for HalfCheetah) occupied by a training trajectory. Queue state coverage for Kitchen (Pixel) is measured as the number of tasks completed at least once during the last 100, 000 environment steps. For Ant, HalfCheetah, Humanoid-Run, and Quadruped (Pixel), a goal distance is calculated by randomly selecting a target goal, executing a goal-reaching policy, and measuring a distance between a final state of the policy and a target goal. For AntMaze and Kitchen (Pixel), the number of reached goals and the number of achieved tasks are measured.

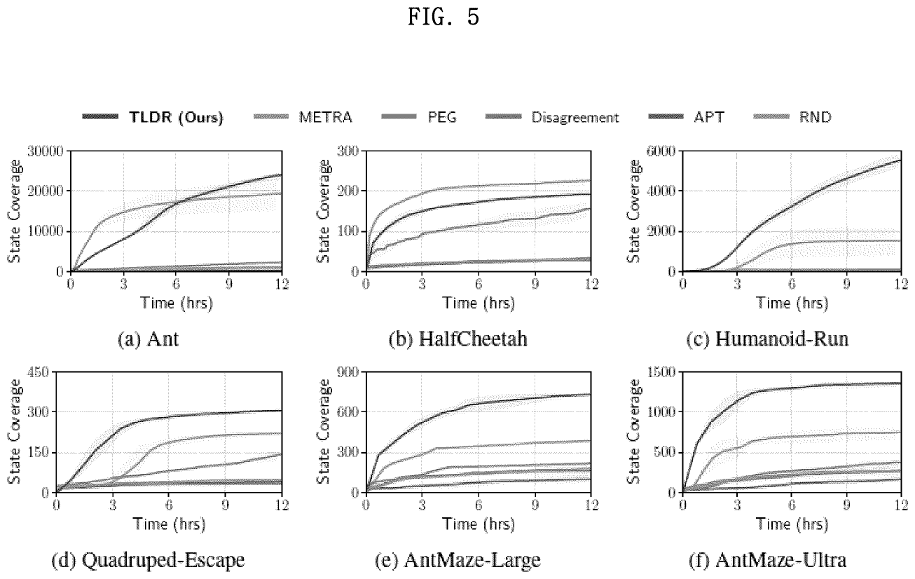

FIG. 5 is a drawing showing the state coverage of state-based environments according to the experimental results of FIG. 4.

In FIG. 5, TLDR outperforms other prior studies except HalfCheetah. METRA learns low-dimensional skills and extends a temporal distance along a few directions specified by the skills, providing a strong inductive bias for simple movement tasks like HalfCheetah. On the other hand, TLDR achieves much larger state coverage in complex environments than METRA and outperforms in AntMaze-Large, AntMaze-Ultra, and Quadruped-Escape environments, where only limited regions are explored, and this shows the superiority of TLDR in complex environments.

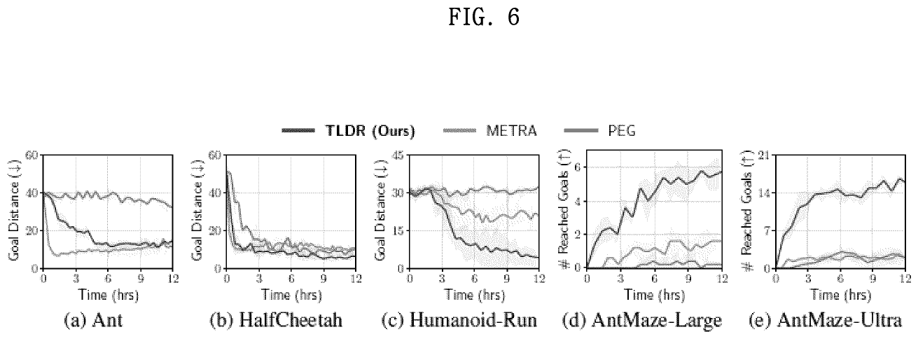

FIG. 6 is a diagram explaining goal achievement indicators of a goal-conditioned policy according to the experimental results of FIG. 4.

In FIG. 6, the goal-reaching performance of TLDR is compared with PEG and METRA. First, an average distance between final states of a goal and a path. Results from (a), (b), and (c) in FIG. 5 show that TLDR may navigate towards a given goal more closely than METRA, or at least on par with METRA. For the AntMaze environments, the number of pre-defined goals reached by the goal-conditioned policy is reported. In FIG. 5, (d) and (e) show that TLDR is the only method to explore different sets of goals in two mazes, demonstrating excellent exploration and goal-condition policy learning capabilities by exploiting a temporal distance.

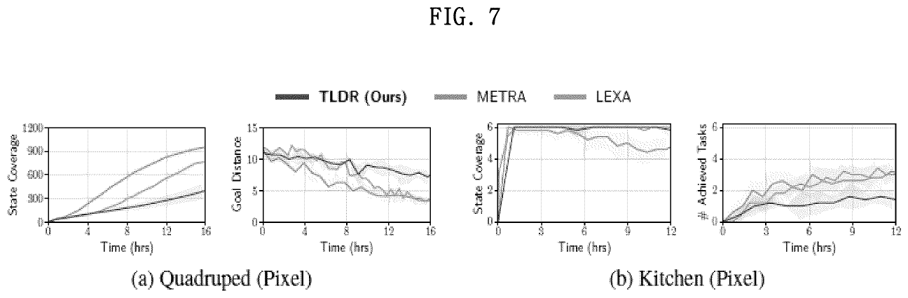

FIG. 7 is a drawing showing the experimental results in a pixel-based environment according to the experimental results of FIG. 4.

In FIG. 7, TLDR is compared with prior studies in pixel-based Quadruped and Kitchen environments. In Quadruped (Pixel), TLDR showed slower learning speed than METRA and LEXA. Additionally, in Kitchen (Pixel), TLDR is able to interact with all six objects during training, but shows a low success rate during evaluation.

That is, in Quadruped (Pixel), TLDR may explore various areas, but the learning speed is slower than LEXA and METRA. In Kitchen (Pixel), TLDR interacts with all six objects during training, but struggles at learning a goal-conditioned policy. Here, it may be hypothesized learning a temporal abstraction is more challenging with pixel observations, which may lead φ, which encodes a temporal distance between states in a latent space, to encode erroneous temporal information.

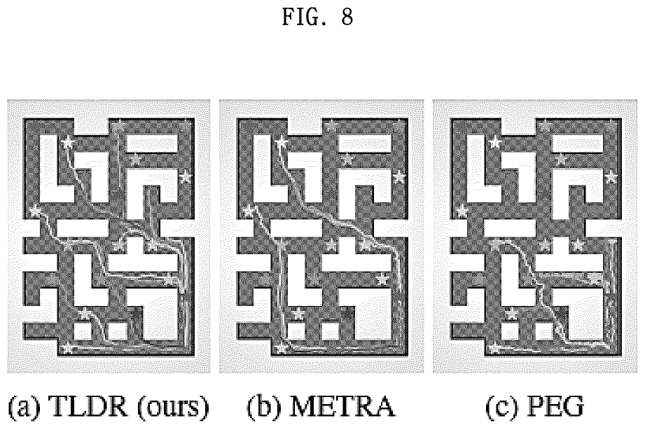

FIG. 8 is a drawing showing the goal-reaching capability in AntMaze-Ultra.

In FIG. 8, goal-reaching actions learned in the AntMaze-Ultra environment is visualized. TLDR is able to successfully reach both near and faraway goals in diverse regions, while METRA and PEG fail to move to diverse goals. METRA is able to reach some goals distant from an initial position, whereas PEG fails to reach temporally faraway goals. This clearly shows the benefit of using a temporal distance in unsupervised GCRL.

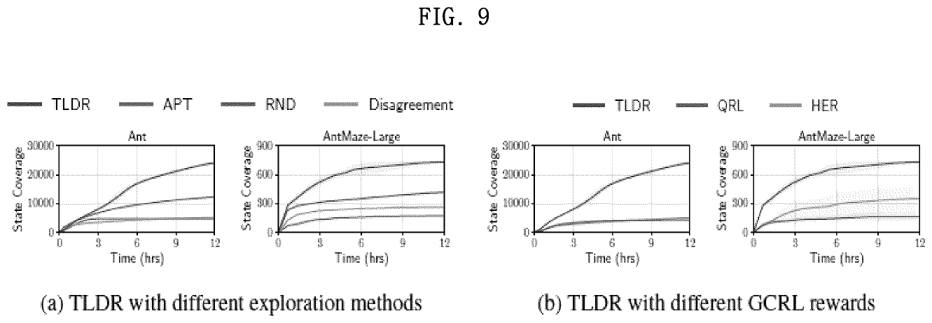

FIG. 9 is a drawing showing the influence of temporal distance-aware representations in exploration and GCRL reward design.

In FIG. 9, to investigate the importance of temporal distance-aware representations, ablation studies on exploration policies and GCRL reward design are conducted. Here, for goal selection and exploration rewards in the exploration policy, the temporal distance ∥φ(s)−z^{(j)}∥ is replaced with other exploration bonuses RND, APT (using ICM notation) and Disagreement. Since the goal-conditioned policy are still trained with the same temporal distance-based rewards as TLDR, only the exploration policy is compared here. As shown in (a) of FIG. 9, using a TLDR reward for goal selection and exploration reward achieves significantly higher performance than other exploration bonuses. This implies that temporal distance-based rewards are effective for unsupervised exploration. Additionally, the GCRL reward design is compared with two goal-conditioned policy learning methods. The two goal-conditioned policy learning methods are as follows.
(1) QRL which uses a quasimetric value function
(2) sparse HER which uses a sparse goal-reaching reward − [symbol] (s≠g)

In FIG. 9, (b), the superior performance of the temporal distance-based GCRL reward is shown, and this highlights the importance of incorporating temporal distance-aware representations in training goal-conditioned policies.

The above description is merely exemplary description of the technical scope of the present disclosure, and it will be understood by those skilled in the art that various changes and modifications can be made without departing from the spirit and scope of the present disclosure as set forth in the following claims.
[National research and development project supporting the present disclosure]
[Project Serial No] 2710006677
[Task Project No] RS-2020-II201361
[Name of department] Ministry of Science and ICT
[Task management (professional) institution name] Institute of Information and Communications Technology Planning and Evaluation
[Research Project name] Nurturing ICT and Broadcasting Innovation Talents
[Research Task Name] Artificial Intelligence Graduate School Support (Yonsei University)
[Name of task performing organization] Yonsei University Industry-University Cooperation

### Foundation

[Research Period] 2024.01.01˜2024.12.31

[Detailed Description of Elements]

| | |
|---|---|
| 100: apparatus for learning temporal | |
| distance-aware representations | |
| 110: initialization unit | 120: learning execution unit |
| 130: policy learning unit | 140: visual distance-aware |
| | representations learning unit |
| 150: controller | |

1. An apparatus for learning temporal distance-aware representations, the apparatus comprising:
an initialization unit configured to initialize a buffer where a goal-conditioned policy, an exploration policy, visual distance-aware representation, and experience data for learning are stored;
a learning execution unit configured to set a goal based on a Temporal Distance-aware Representations (TLDR) reward in a current episode, and determine a new state and action data through execution of the goal-conditioned policy and the exploration policy to reach the goal;
a policy learning unit configured to learn the goal-conditioned policy based on experience of reaching the goal, and learn the exploration policy based on a visual distance to the goal; and
a visual distance-aware representations learning unit configured to learn the visual distance-aware representations by encoding a visual distance between the states based on constraints.

2. The apparatus of claim 1, wherein the initialization unit initializes the goal-conditioned policy through goal setting and initializes the exploration policy through generation of actions for exploration.

3. The apparatus of claim 1, wherein the learning execution unit samples a state of the current episode, samples a mini-batch from the buffer, and then selects a state with a highest TLDR reward from the mini-batch to set the goal.

4. The apparatus of claim 3, wherein the learning execution unit executes the goal-conditioned policy for a predetermined period of time to determine whether the goal has been reached or a predetermined stage before the goal has been reached.

5. The apparatus of claim 4, wherein, when it is determined that the goal or the predetermined stage has been reached, the learning execution unit stores, in the buffer, a new state and action data determined through the execution of the exploration policy.

6. The apparatus of claim 1, wherein the policy learning unit updates the goal-conditioned policy by learning the action data to maximize a probability of reaching the goal through the goal-conditioned policy using Hindsight Experience Replay (HER) technique.

7. The apparatus of claim 6, wherein the policy learning unit selects the action data by performing reinforcement learning to minimize a visual distance through a loss function.

8. The apparatus of claim 1, wherein the policy learning unit learns the exploration policy by expanding a state space for exploration of various states and discovering a new state to which an agent is able to move based on the visual distance to the goal.

9. The apparatus of claim 1, wherein the visual distance-aware representations learning unit performs optimization of the constraints to prevent distortion of the visual distance between the states, and implements the visual distance-aware representations using a neural network that encodes the visual distance between the states in a latent space.

10. The apparatus of claim 9, wherein the visual distance-aware representations learning unit optimizes the visual distance-aware representations by performing optimization of the constraints and maximization of the visual distance using a double gradient descent method.

11. A method for learning temporal distance-aware representations, performed by an apparatus for learning temporal distance-aware representations, comprising:
initializing a buffer where a goal-conditioned policy, an exploration policy, visual distance-aware representation, and experience data for learning are stored;
setting a goal based on a Temporal Distance-aware Representations (TLDR) reward in a current episode, and determining a new state and action data through execution of the goal-conditioned policy and the exploration policy to reach the goal;
learning the goal-conditioned policy based on experience of reaching the goal, and learning the exploration policy based on a visual distance to the goal; and
learning the visual distance-aware representations by encoding a visual distance between the states based on constraints.
